(19) United States
(12) Patent Application Publication
(10) Pub. No.: US 2010/0002149 A1
(43) Pub. Date: Jan. 7, 2010

(54) METHOD AND APPARATUS FOR DETECTING SLOW MOTION

(75) Inventors: Enno Lars Ehlers, Sterup (DE); Johannes Weda, Eindhoven (NL); Mauro Barbieri, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/514,134

(22) PCT Filed: Nov. 7, 2007
(86) PCT No.: PCT/IB2007/054515

§ 371 Date: May 8, 2009

(30) Foreign Application Priority Data
Nov. 14, 2006 (EP) 06124002.4

(51) Int. Cl. H04N 5/14

(52) U.S. Cl. 348/699; 348/E05.062

(57) ABSTRACT

The occurrence of slow motion in a video sequence is detected by: extracting a feature of luminosity for each of a plurality of frames of a video sequence, step 103; determining differences between the extracted features of luminosity, step 105; performing frequency analysis on the determined differences, step 109; and detecting the occurrence of slow motion in said video sequence when a frequency variation between the differences exceeds a predetermined threshold.

### FIELD OF THE INVENTION

The present invention relates to method and apparatus for detecting slow motion in a video sequence.

### BACKGROUND OF THE INVENTION

A huge amount of today's broadcast is sports content. While current and emerging consumer products like HDD-recorders, TiVo or the Microsoft Media Center PC's give users the possibility to record a lot of sport content, they do not provide “quick and easy” browsing through recordings and do not provide means for summarizing or shortening of sports broadcasts.

When users already know the results of a sport event, watching a recorded broadcasts of the event might become boring and thus it creates the need for rapid browsing of a recording or watching a shortened version that includes only the interesting parts of the event. However, this is not possible with existing, conventional recorders.

One known technique is to automatically extract highlights (e.g. goals in football, long rallies in tennis, fouls, etc.). In most sports, slow motion sequences (replays) can be considered an indication of a highlight, as directors usually decide to show interesting actions in slow motion from multiple angles. Thus locating slow motion portions in a video sequence is a way of automatically extracting highlights, in particular, of sports.

Broadcasters use two different techniques for generating slow motion sequences. The first one, interpolation, generates slow motion sequences as a post-processing step. The output of a normal camera, typically having a frame rate of 25 or 30 frames per second, is slowed down by inserting repeated or interpolated frames. In a second technique, broadcasters use high-speed cameras that are capable of capturing video with frame rates up to 75 and 90 frames per second. If the video is then broadcast at 25 or 30 frames per second without skipping frames, the result is a slow motion sequence.

Slow motion sequences produced with high-speed cameras are preferable to slow motion sequences produced by interpolation. Because high-speed cameras take more samples of an object in the same time the result is that object motion looks smoother.

Humans easily detect slow motion parts by observing that objects in the sequence do not behave as expected. From previous experiences, humans know that certain objects have certain masses, elasticity, friction, etc., and they expect them to behave accordingly. For example, when billiard balls collide at a certain speed, there is an expected speed at which they recoil. Humans recognize slow motions by noticing that these objects break the expected behavioral rules.

There are known systems that detect slow motion video sequences created by interpolation for example V. Kobla and D. Doermann, “Detection of Slow-Motion Replays for Identify Sports Videos”, Proceedings of IEEE Third Workshop for Multimedia Sport Processing, pp 135-140, 1999 and V. Kobla, D. DeMenthon and D. Doermann, “Identification of sports video using replay text, and camera motion features”, Proc. of the SPIE Conference on Storage and Retrieval for Media Database, Vol. 3972, January, 2000, pp 332-343. These systems usually search for repeated or interpolated frames. Other systems have been disclosed that can detect slow motion video sequences created with high-speed cameras for example L. Wungt, X. Liut, S. Liut, G. Xui and H.-Y. Shumt, “Generic Slow-Motion Replay Detection in Sports Video”, 2004 International Conference on Image Processing (ICIP), pp 1585-1588. The use of these techniques is inspired by the way humans recognize slow motion. Algorithms are trained with motion features of slow motion scenes and non-slow motion scenes to allow them to learn the difference between them. These systems are usually specialized for detecting slow motion sequences in specific (detected) camera shots and for a specific sport. As this method is very error prone, some systems additionally search for wipe transitions or perform template matching with hand picked transition logos that broadcasters introduce before replay sequences (especially in soccer broadcasts), for example X. Tong, H. Lu, Q. Liu and H. Jin, “Replay Detection in Broadcasting Sports Video”, Proceedings of the Third International Conference on Image and Graphics (ICIG'04).

Detecting slow motions sequences created by interpolation, works quite accurately whereas building a system that recognizes slow motion sequences created with high-speed cameras is error prone and requires a huge and impractical training for each type of sport. Relying on wipe and logo detectors is also not possible because it is very difficult to build reliable wipe and logo transition detectors. The best-known systems find 70-80% of all slow motions but only in the specific sport they were trained for and with low precision (˜60%).

As high-speed cameras become cheaper and cheaper, and broadcasters try to enhance the quality of their programs, slow motion sequences made using high-speed cameras are now used for the majority of sports broadcasts, while slow motion by interpolation is seldom used.

### SUMMARY OF THE INVENTION

The present invention seeks to provide accurate automatic detection of slow-motion taken by high-speed cameras.

This is achieved, according to a first aspect of the present invention, by a method for detecting the occurrence of slow motion in a video sequence, the method comprising the steps of: extracting a feature of luminosity for each of a plurality of frames of a video sequence; determining differences between the extracted features of luminosity; performing frequency analysis on the determined differences between the extracted features of luminosity; and detecting the occurrence of slow motion in the video sequence when a frequency variation between the differences exceeds a predetermined threshold.

This is also achieved, according to another aspect of the present invention, by an apparatus for detecting the occurrence of slow motion in a video sequence, the apparatus comprising: a feature extractor for extracting a feature of luminosity for each of a plurality of frames of a video sequence; an analyzer for determining differences between the extracted features of luminosity and performing frequency analysis on the determined differences; a processing means for detecting the occurrence of slow motion in said video sequence when a frequency variation between the differences exceeds a predetermined threshold.

The present invention is based on the physical effect that flickering of halogen lamps has a measurable influence on the luminance of video in shots taken by high-speed cameras while this effect does not occur with normal cameras. Therefore, detecting slow-motion when the differences between extracted features of luminosity exceed a threshold, i.e. are significant provides an accurate and simple technique to detect slow-motion created by high-speed cameras. As a result highlights of sport broadcasts can be easily and accurately detected and can be used for summarizing sport and can be used for context-based browsing applications in digital video recorders.

### BRIEF DESCRIPTION OF DRAWINGS

For a more complete understanding of the present invention, reference is now made to the following description taken in conjunction with the accompanying drawings in which:

FIG. 1 is a flowchart of the steps of the method according to a first embodiment of the present invention;

FIG. 2 is a flowchart of the steps of the method according to a second embodiment of the present invention; and

FIG. 3 is a simplified schematic diagram of apparatus according to an embodiment of the present invention.

### DETAILED DESCRIPTION OF AN EMBODIMENT OF THE INVENTION

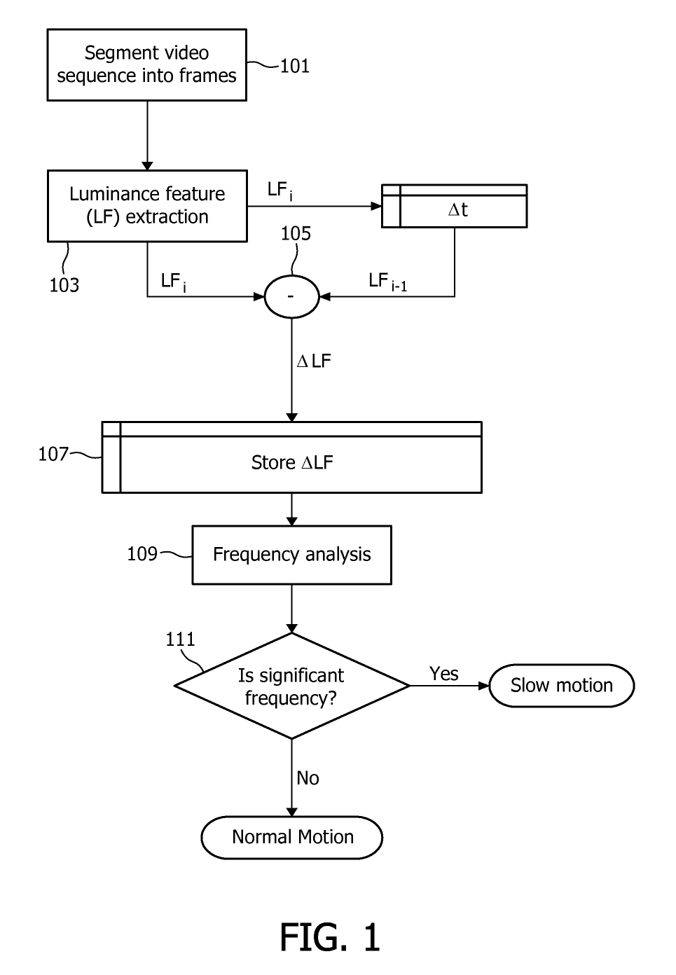

With reference to FIG. 1, the first embodiment of the present invention will be described in detail. In step 101, a video sequence comprising a plurality of frames is input. For each frame i a luminosity feature LFᵢ (the average luminance over the frame or, alternatively, at least a part of a luminance histogram) is extracted, step 103. Subsequent luminosity features are subtracted, ΔLF=LFᵢ−LFᵢ₋₁, step 105. The result ΔLF is stored in a FIFO buffer, step 107. A frequency analysis (for example Fourier decomposition) is performed, step 109, on the ΔLF samples saved in the buffer to give the frequency spectrum of the sample ΔLF. If the spectrum has a dominant frequency (i.e. a peak in the spectrogram that is significantly higher than the rest) then slow motion is detected, step 111.

The system of the present invention is based on detecting a physical effect known as temporal aliasing. Two examples of temporal aliasing are as follows:

The sun moves east to west in the sky, with 24 hours between sunrises. If one were to take a picture of the sky every 23 hours, the sun would appear to move west to east, with 24×23=552 hours between sunrises. Note that in both cases, taking a picture every hour and every 23 hours would result in the same pictures. If one were to take a picture every N*24 hours (N is an integer), the sun would even appear to stand still.

The same phenomenon causes spiked wheels to apparently turn at the wrong speed or in the wrong direction when filmed, or illuminated with a flashing light source—such as fluorescent lamp, a CRT, or a strobe light.

This effect is used in a sport event as follows. Sport events are illuminated with halogen lamps. The lamps flicker with a frequency of 100 Hz (or 120 Hz, depending on the country), due to the alternating current that is used to power these lamps. This flickering is not visible for human eyes.

A normal camera records the event at exactly 25 frames per second. This means that the camera takes a snapshot every 40 milliseconds. The lamps flicker with a period of 10 milliseconds. Since the period of the camera is exactly an integer value multiple of the period of the lamps, the flickering is invisible for such cameras.

However, when a high-speed camera records the event at a frequency of 75 or 90 Hz, the period is no longer an integer value larger than the period of the lamps, and the flickering is visible in the recordings.

Suppose that a lamp flickers at a frequency fₗ. This flickering can be noticed and measured only when the scene is recorded with a camera that operates at a frame rate f_{c} that is not a multiple of fₗ:

fₗ≠n·f_{c}

Due to the fact that the Nyquist-Shannon criterion (2f_{H}<fₛₐₘₚₗₑ) is not met, the true frequency of the flickering of the lamps cannot be retrieved. A lower frequency is instead measurable in the high-speed recording. Therefore, detection of a lower dominant frequency gives an accurate indication of slow motion.

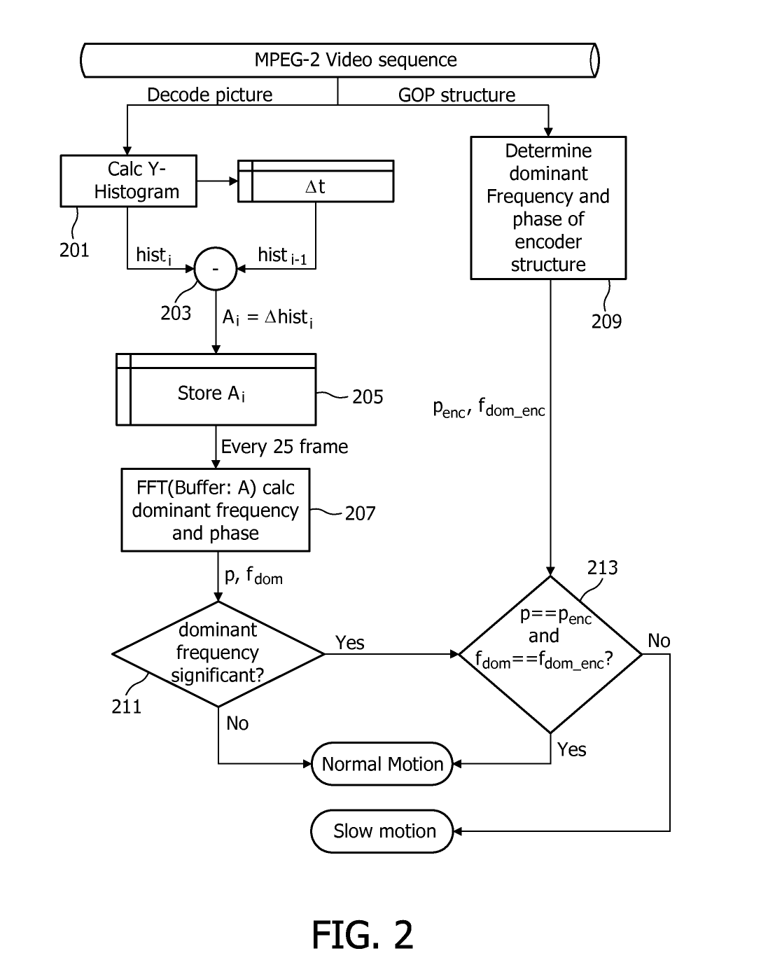

With reference to FIG. 2, the second embodiment, which takes into account the particularities of MPEG encoding, will be described in detail. Broadcasts are typically encoded using the MPEG-2 video compression standard. However, the encoder may disturb the input in such a way that an erroneous dominant frequency occurs. To illustrate this problem, consider, for example, a GOP-structure of IBPBPBPBPB of a video sequence. The average luminance increases for each I and P frames and decreases for each B frame. The resulting pattern is:

I_{B}P_{B}P_{B}P_{B}P_{B}

The encoder noise produces flickering in the average luminance with a frequency that is dependant on the GOP-structure. This can generate false positive slow motion detections. The method of the second embodiment excludes these false positives.

As shown in FIG. 2, the input MPEG-2 video sequence is segmented into a plurality of frames and decoded. A Y-histogram of the decoded input sequence is calculated for each frame, step 201. The Y-histogram is subtracted bin-wise to give the sum of the absolute difference between subsequent elements in the vector:

Aᵢ=Δhist=Σ|histᵢ−histᵢ₋₁|

Alternatively, the difference may be calculated by histogram intersection. The value Aᵢ is then stored in a buffer, step 205. In the particular example illustrated, every 25 frames are analyzed by Fast Fourier Transform (FFT) to calculate the dominant frequency and phase, step 207. Although in this example FFT of the content is performed every 25 frames, this can be performed on every frame but, as can be appreciated, this would significantly slow computation. Therefore, in performing the FFT to windows of, say, 100 samples shifted every 25 frames as described. Further, the dominant frequency and phase of the encoder is determined, step 209. If the dominant frequency of Aᵢ is significant as described above with respect to the first embodiment, step 211 and the dominant frequency and phase do not correspond to that of the encoder, step 213, then slow-motion is indicated. Therefore, in this embodiment frequency and phase of the encoder noise is determined and before declaring a sequence as slow motion, it verifies whether a significant frequency could have been produced by the encoder and is not the result of slow motion.

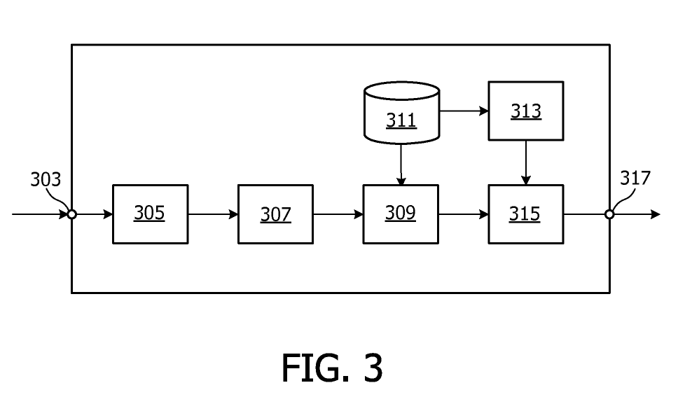

Apparatus 301 for detecting slow motion in a video sequence is shown in FIG. 3.

The apparatus comprises an input terminal 303 connected to means 305 for receiving a video sequence input on the input terminal 303, the video sequence comprising a plurality of frames. The receiving means 305 is connected to a feature extractor 307 for extracting a luminosity feature for each frame. The extracting means 305 is connected to a subtractor 309 for subtracting a luminosity feature of a frame, extracted by the feature extractor 307, from a luminosity feature of a subsequent frame to generate the differences in subsequent luminosity features ΔLF. The differences are then output and stored in a storage means 311 such as a FIFO buffer. The stored differences are retrieved from the buffer 311 and analyzed by a Fast Fourier Transform (FFT) 313. The Fourier decomposed samples are then processed by a processor 315 to determine if significant frequency variation has occurred. If it has then slow motion has been detected and this is output on the output terminal 317 to indicate to the user occurrence of slow motion or provided to means for automatic summarization or to store this information for later retrieval by the user during playback or for utilization by means for automatically generating a summary of the video sequence.

As slow motion sequences are indicators for highlights, the present invention provides an improvement in lots of applications for digital video recorders, such as: automatic summarization of sport content (e.g. sport-in-a-minute); intelligent browsing by zapping to highlights; and search and retrieval of spectacular scenes.

It provides a low-cost implementation in terms of computational costs, and is of high interest for real time applications in digital video recorders such as: instant slow motion replay.

Although preferred embodiments of the present invention have been illustrated in the accompanying drawings and described in the foregoing description, it will be understood that the invention is not limited to the embodiments disclosed but capable of numerous modifications without departing from the scope of the invention as set out in the following claims. The invention resides in each and every novel characteristic feature and each and every combination of characteristic features. Reference numerals in the claims do not limit their protective scope. Use of the verb “to comprise” and its conjugations does not exclude the presence of elements other than those stated in the claims. Use of the article “a” or “an” preceding an element does not exclude the presence of a plurality of such elements.

‘Means’, as will be apparent to a person skilled in the art, are meant to include any hardware (such as separate or integrated circuits or electronic elements) or software (such as programs or parts of programs) which perform in operation or are designed to perform a specified function, be it solely or in conjunction with other functions, be it in isolation or in co-operation with other elements. The invention can be implemented by means of hardware comprising several distinct elements, and by means of a suitably programmed computer. In the apparatus claim enumerating several means, several of these means can be embodied by one and the same item of hardware. ‘Computer program product’ is to be understood to mean any software product stored on a computer-readable medium, such as a floppy disk, downloadable via a network, such as the Internet, or marketable in any other manner.

1. A method for detecting the occurrence of slow motion in a video sequence, the method comprising the steps of:
extracting a feature of luminosity for each of a plurality of frames of a video sequence;
determining differences between said extracted features of luminosity;
performing frequency analysis on said determined differences between said extracted features of luminosity; and
detecting the occurrence of slow motion in said video sequence when a frequency variation between said differences exceeds a predetermined threshold.

2. A method according to claim 1, wherein the step of determining differences between said extracted features of luminosity comprises:
subtracting said extracted feature of luminosity of a frame from said extracted feature of luminosity of a previous or subsequent frame.

3. A method according to claim 1, wherein the step of performing frequency analysis on said determined differences includes Fourier decomposition of said determined differences.

4. A method according to claim 3, wherein the step of detecting the occurrence of slow motion in said video sequence comprises:
detecting a peak in the frequency spectrum generated by the Fourier decomposition.

5. A method according to claim 1, wherein said feature of luminosity comprises the average luminance over said frame.

6. A method according to claim 1, wherein the video sequence is compressed and the step of detecting the occurrence of slow motion in said video sequence further comprises the steps of:
compensating said determined differences between said extracted features of luminosity for noise; and
detecting the occurrence of slow motion in said video sequence when a frequency variation between said compensated differences exceeds a predetermined threshold.

7. A method according to claim 6, wherein the step of extracting a feature of luminosity comprises:
decoding the video sequence;
calculating a Y-histogram of said decoded video sequence; and
wherein the step of determining a difference between said extracted features of luminosity comprises:
determining the sum of the absolute difference between subsequent elements of said Y-histogram.

8. A computer program product comprising a plurality of program code portions for carrying out the method according to claim 1.

9. Apparatus for detecting the occurrence of slow motion in a video sequence, the apparatus comprising:
a feature extractor for extracting a feature of luminosity for each of a plurality of frames of a video sequence;
an analyzer for determining differences between said extracted features of luminosity and performing frequency analysis on said determined differences;
a processing means for detecting the occurrence of slow motion in said video sequence when a frequency variation between said differences exceeds a predetermined threshold.

10. Apparatus to claim 9, wherein the analyzer comprises:
a subtractor for subtracting said extracted feature of luminosity of a frame from said extracted feature of luminosity of a previous or subsequent frame.

11. Apparatus according to claim 9, wherein the apparatus further comprises:
a Fast Fourier Transform for Fourier decomposing said determined differences.

12. Apparatus according to claim 11, wherein the apparatus further comprises: means for detecting a peak in the frequency spectrum generated by the Fourier decomposition.

13. Apparatus according to claim 9, wherein the video sequence is compressed and the processing means further comprises:
a compensator for compensating said determined differences between said extracted features of luminosity for noise; and
said processing means detecting the occurrence of slow motion in said video sequence when a frequency variation between said compensated differences exceeds a predetermined threshold.
